(19) United States
(12) Patent Application Publication
(10) Pub. No.: US 2008/0299463 A1
(43) Pub. Date: Dec. 4, 2008

(54) Nonaqueous Electrolyte Secondary Battery

(75) Inventors: Kazunori Donoue, Hyogo (JP); Takao Inoue, Aichi (JP); Denis Yau Wai Yu, Hyogo (JP); Masahisa Fujimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 11/814,234

(22) PCT Filed: Jan. 10, 2006
(86) PCT No.: PCT/JP2006/300123

§ 371 Date: Jul. 18, 2007

(30) Foreign Application Priority Data
Feb. 25, 2005 (JP) 2005-050553

(51) Int. Cl. H01M 6/16

(52) U.S. Cl. 429/342

(57) ABSTRACT

A nonaqueous electrolyte secondary battery that even at high-rate discharge wherein discharge is carried out at relatively large current, can attain an increase of discharge capacity. There is provided a nonaqueous electrolyte secondary battery comprising positive electrode (2), the positive electrode (2) including a collector and, superimposed thereon, a mixture layer containing a positive electrode active material in which lithium iron phosphate (LiFePO₄) is contained, a conductive agent and a binder, the mixture layer exhibiting a mixture packing density after electrode formation of ≧1.7 g/cm³, and further comprising nonaqueous electrolyte (5) containing a solvent in which ethylene carbonate and a linear ether such as 1,2-dimethoxyethane are contained.

### TECHNICAL FIELD

The present invention relates to a nonaqueous electrolyte secondary battery, and more particularly, it relates to a nonaqueous electrolyte secondary battery comprising a positive electrode having a positive electrode active material containing lithium iron phosphate.

### BACKGROUND ART

A nonaqueous electrolyte secondary battery carrying out charge/discharge by moving lithium ions between a positive electrode and a negative electrode through a nonaqueous electrolyte is generally known as a secondary battery having a high energy density.

In such a nonaqueous electrolyte secondary battery, LiCoO₂ is employed as an active material for the positive material while a carbon material capable of occluding and releasing lithium ions is employed as the negative electrode in general. Further, a substance prepared by dissolving an electrolyte composed of lithium salt such as LiBF₄ or LiPF₆ in an organic solvent such as ethylene carbonate or diethyl carbonate is used as the nonaqueous electrolyte.

The aforementioned conventional nonaqueous electrolyte secondary battery employing LiCoO₂ as the positive electrode active material has such an inconvenience that the material cost for the nonaqueous electrolyte secondary battery is increased due to the limited reserve of cobalt (Co). Further, a battery employing LiCoO₂ has such an inconvenience that thermal stability is extremely reduced if the battery in a charged state reaches a temperature remarkably higher than that in an ordinarily used state. Therefore, various materials are studied as the materials employed as the positive electrode active material in place of LiCoO₂.

As one of these materials, olivinic lithium phosphate such as lithium iron phosphate has been recently noted as a positive electrode material substituting for LiCoO₂. The general formula for this olivinic lithium phosphate is expressed as LiMPO₄ (M represents at least one element among Co, Ni, Mn and Fe). The operating voltage of a nonaqueous electrolyte secondary battery employing olivinic lithium phosphate varies with the type of the metallic element M, whereby the metallic element M can be selected in response to a desired voltage. Therefore, the nonaqueous electrolyte secondary battery can be applied to wide-ranging use. Further, this nonaqueous electrolyte secondary battery employing olivinic lithium phosphate has a relatively high theoretic discharge capacity of about 140 mAh/g to 170 mAh/g, whereby the battery capacity per unit mass can be increased. Therefore, the nonaqueous electrolyte secondary battery can be miniaturized. If iron (Fe) is selected as the metallic element M in the aforementioned general formula, in addition, the material cost can be remarkably reduced as compared with an aqueous electrolyte secondary battery prepared from Co or the like exhibiting a low abundance, since iron exhibits a high abundance and is low-priced.

However, olivinic lithium phosphate has such inconveniences that the same has extremely low electron conductivity as compared with LiCoO₂, LiNiO₂, LiMn₂O₄ and the like and that elimination/insertion reaction of lithium ions is slow in charge/discharge of the nonaqueous electrolyte secondary battery. In the nonaqueous electrolyte secondary battery employing olivinic lithium phosphate, therefore, there has been such an inconvenience that the discharge capacity in high-rate discharge carried out with relatively large current.

Therefore, a technique of improving electron conductivity of a nonaqueous electrolyte secondary battery employing a positive electrode active material composed of olivinic lithium phosphate is proposed in general. This is disclosed in Japanese Patent Laying-Open No. 2002-110162, for example. The aforementioned Japanese Patent Laying-Open No. 2002-110162 proposes a nonaqueous electrolyte secondary battery, having a positive electrode composed of a positive electrode active material employing lithium iron phosphate, a conductive agent and a collector, improving contact areas between the positive electrode active material, the conductive agent and the collector by setting the particle size of primary particles of lithium iron phosphate to not more than 3.1 μm thereby setting the specific surface area of the positive electrode active material to at least a constant level. According to Japanese Patent Laying-Open No. 2002-110162, electron conductivity of the positive electrode active material of the nonaqueous electrolyte secondary battery is improved by improving the contact areas between the positive electrode active material, the conductive agent and the collector in this manner.

In the nonaqueous electrolyte secondary battery according to Japanese Patent Laying-Open No. 2002-110162, however, adhesiveness between a positive electrode mixture and the conductive agent, between the conductive agent and the collector and between the collector and the positive electrode mixture is reduced if a positive electrode mixture layer composed of lithium iron phosphate, the conductive agent etc. is charged in a relatively low density without rolling or the like also when the contact areas between the positive electrode active material, the conductive agent and the collector are increased, whereby electron conductivity in the positive electrode is inconveniently reduced. In this case, there is such a problem that the discharge capacity is reduced in high-rate discharge carried out with relatively large current.

### DISCLOSURE OF THE INVENTION

The present invention has been proposed in order to solve the aforementioned problem, and an object of the present invention is to provide a nonaqueous electrolyte secondary battery capable of improving the discharge capacity also in high-rate discharge carried out with relatively large current.

In order to attain the aforementioned object, the inventor has found as a result of a deep study that a high discharge capacity can be attained also in high-rate discharge when setting a mixture filling density of a mixture layer containing a positive electrode active material, a conductive agent and a binder after electrode formation to at least 1.7 g/cm³ and employing a solvent containing ethylene carbonate and chain carbonate as a solvent of a nonaqueous electrolyte. In other words, a nonaqueous electrolyte secondary battery according to an aspect of the present invention comprises a positive electrode including a collector and a mixture layer, formed on the collector, containing a positive electrode active material containing lithium iron phosphate, a conductive agent and a binder with the mixture layer exhibiting a mixture filling density of at least 1.7 g/cm³ after electrode formation and a nonaqueous electrolyte containing a solvent containing ethylene carbonate and chain ether.

In the nonaqueous electrolyte secondary battery according to this aspect, the mixture filling density of the mixture layer having the positive electrode active material containing lithium iron phosphate (LiFePO₄), the conductive agent and the binder is so set to at least 1.7 g/cm³ that adhesiveness between the positive electrode active material and the conductive agent, between the conductive agent and the collector and between the positive electrode active material and the collector can be improved. Thus, electron conductivity in the positive electrode can be improved. Consequently, a high discharge capacity can be maintained not only in ordinary discharge but also in high-rate discharge carried out with relatively large current. Further, the solvent prepared by adding the chain ether having extremely low viscosity to the ethylene carbonate having a high dielectric constant is so employed as the solvent of the nonaqueous electrolyte that the viscosity of the nonaqueous electrolyte is reduced, whereby the positive electrode mixture layer can be sufficiently impregnated with the solvent and the traveling speed of lithium ions can be improved also when voids in the positive electrode mixture layer are reduced in size by setting the positive electrode mixture filling density to at least 1.7 g/cm³. Thus, a large quantity of lithium ions can be moved to the nonaqueous electrolyte in the vicinity of the positive electrode active material, whereby the lithium ion concentration can be in the nonaqueous electrolyte in the vicinity of the positive electrode active material during discharge. Consequently, the discharge capacity in high-rate discharge can be further improved.

In the nonaqueous electrolyte secondary battery according to the aforementioned aspect, the solvent of the nonaqueous electrolyte preferably contains chain carbonate in addition to the ethylene carbonate and the chain ether. According to this structure, the chain carbonate can inhibit the chain ether from co-insertion into natural graphite also when the natural graphite is employed for a negative electrode active material. Thus, reduction of an initial charge/discharge effect and reduction of cyclicity resulting from co-insertion of the chain ether into natural graphite can be suppressed when the natural graphite is employed as the negative electrode active material.

In the nonaqueous electrolyte secondary battery according to the aforementioned aspect, the chain carbonate constituting the solvent of the nonaqueous electrolyte is preferably diethyl carbonate. According to this structure, the diethyl carbonate can inhibit 1,2-dimethoxyethane which is chain ether from co-insertion into natural graphite also when the natural graphite is employed for the negative electrode active material. Thus, reduction of the initial charge/discharge effect and reduction of cyclicity resulting from co-insertion of 1,2-dimethoxyethane which is chain ether into natural graphite can be suppressed when the natural graphite is employed as the negative electrode active material.

In the nonaqueous electrolyte secondary battery according to the aforementioned aspect, the chain carbonate constituting the solvent of the nonaqueous electrolyte is preferably dimethyl carbonate. According to this structure, the dimethyl carbonate can inhibit 1,2-dimethoxyethane which is chain ether from co-insertion into natural graphite also when the natural graphite is employed for the negative electrode active material. Thus, reduction of the initial charge/discharge effect and reduction of cyclicity resulting from co-insertion of 1,2-dimethoxyethane which is chain ether into natural graphite can be suppressed when the natural graphite is employed as the negative electrode active material.

In this case, the content of the dimethyl carbonate in the solvent of the nonaqueous electrolyte is preferably at least 50% in volume ratio. According to this structure, the dimethyl carbonate can easily inhibit 1,2-dimethoxyethane which is chain ether from co-insertion into natural graphite also when the natural graphite is employed for the negative electrode active material. Thus, reduction of the initial charge/discharge effect and reduction of cyclicity resulting from co-insertion of 1,2-dimethoxyethane which is chain ether into natural graphite can be easily suppressed when the natural graphite is employed for the negative electrode active material.

In the nonaqueous electrolyte secondary battery according to the aforementioned aspect, the content of the chain ether in the solvent of the nonaqueous electrolyte is preferably at least 10% in volume ratio. When the content of the chain ether is set to at least 10% in volume ratio in this manner, the viscosity of the nonaqueous electrolyte can be reliably reduced, whereby the traveling speed of lithium ions can be reliably improved. Thus, the discharge capacity in high-rate discharge can be reliably improved.

In the nonaqueous electrolyte secondary battery according to the aforementioned aspect, the chain ether constituting the solvent of the nonaqueous electrolyte is preferably 1,2-dimethoxyethane. According to this structure, the viscosity of the nonaqueous electrolyte can be reduced by employing 1,2-dimethoxyethane having extremely low viscosity, whereby the traveling speed of lithium ions can be improved. Thus, the discharge capacity in high-rate discharge can be further improved.

In the nonaqueous electrolyte secondary battery according to the aforementioned aspect, the solvent of the nonaqueous electrolyte is preferably any one of a solvent containing the ethylene carbonate and the 1,2-dimethoxyethane, a solvent containing the ethylene carbonate, the 1,2-dimethoxyethane and the dimethyl carbonate and a solvent containing the ethylene carbonate, the 1,2-dimethoxyethane and the diethyl carbonate. When such a solvent is employed, the viscosity of the nonaqueous electrolyte can be easily reduced, whereby the traveling speed of lithium ions can be improved.

In the nonaqueous electrolyte secondary battery according to the aforementioned aspect, the solvent of the nonaqueous electrolyte is preferably the solvent containing the ethylene carbonate and the 1,2-dimethoxyethane. When such a solvent containing ethylene carbonate and 1,2-dimethoxyethane is employed, the dielectric constant of the nonaqueous electrolyte can be easily increased, while the viscosity of the nonaqueous electrolyte can be easily reduced. Consequently, the traveling speed of lithium ions can be easily improved.

In the nonaqueous electrolyte secondary battery according to the aforementioned aspect, the solvent of the nonaqueous electrolyte is preferably the solvent containing the ethylene carbonate, the 1,2-dimethoxyethane and the dimethyl carbonate. When such a solvent containing ethylene carbonate, 1,2-dimethoxyethane and dimethyl carbonate is employed, the dielectric constant of the nonaqueous electrolyte can be easily increased while the viscosity of the nonaqueous electrolyte can be easily reduced, and the dimethyl carbonate can easily inhibit the 1,2-dimethoxyethane from co-insertion into natural graphite also when the natural graphite is employed for the negative electrode active material. Thus, the traveling speed of lithium ions can be easily improved, while reduction of the initial charge/discharge effect and reduction of cyclicity resulting from co-insertion of 1,2-dimethoxyethane into the natural graphite can be easily suppressed.

In the nonaqueous electrolyte secondary battery according to the aforementioned aspect, the solvent of the nonaqueous electrolyte is preferably the solvent containing the ethylene carbonate, the 1,2-dimethoxyethane and the diethyl carbonate. When such a solvent containing ethylene carbonate, 1,2-dimethoxyethane and diethyl carbonate is employed, the dielectric constant of the nonaqueous electrolyte can be easily increased while the viscosity of the nonaqueous electrolyte can be easily reduced, and the diethyl carbonate can easily inhibit the 1,2-dimethoxyethane from co-insertion into natural graphite also when the natural graphite is employed for the negative electrode active material. Thus, the traveling speed of lithium ions can be easily improved, while reduction of the initial charge/discharge effect and reduction of cyclicity resulting from co-insertion of 1,2-dimethoxyethane into the natural graphite can be easily suppressed.

In the nonaqueous electrolyte secondary battery according to the aforementioned aspect, the content of the ethylene carbonate in the solvent of the nonaqueous electrolyte is preferably at least 10% in volume ratio. According to this structure, the dielectric constant of the nonaqueous electrolyte can be easily increased by setting the content of ethylene carbonate having a high dielectric constant to a least 10% in volume ratio when the solvent of the nonaqueous electrolyte contains the chain ether, whereby the traveling speed of lithium ions can be easily improved.

In the nonaqueous electrolyte secondary battery according to the aforementioned aspect, the nonaqueous electrolyte may be so formed as to contain an electrolyte composed of lithium phosphorus hexafluoride.

In the nonaqueous electrolyte secondary battery according to the aforementioned aspect, the mixture layer may be so formed as to contain the positive electrode active material containing lithium iron phosphate, a conductive agent containing acetylene black and a binder containing polyvinylidene fluoride.

### BRIEF DESCRIPTION OF THE DRAWINGS

FIG. 1 A perspective view showing a test cell prepared for checking characteristics of positive electrodes and solvents of nonaqueous electrolyte secondary batteries according to Examples.

### BEST MODES FOR CARRYING OUT THE INVENTION

Examples of the present invention are now described.

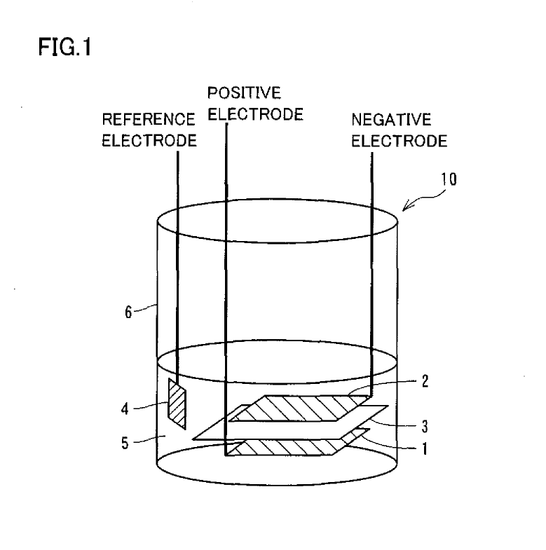

In this application, positive electrodes and nonaqueous electrolytes of nonaqueous electrolyte secondary batteries according to the following Examples 1 to 10 were prepared as Examples corresponding to the present invention, while positive electrodes and nonaqueous electrolytes of nonaqueous electrolyte secondary batteries according to the following comparative examples 1 and 2 were prepared as comparative examples. The nonaqueous electrolyte secondary batteries including the positive electrodes and the nonaqueous electrolytes according to Examples 1 to 10 and comparative examples 1 and 2 were prepared and discharge capacities were checked with a test cell shown in FIG. 1. Examples and comparative examples are now described in detail.

[Relation Between Mixture Filling Density of Positive Electrode Mixture Layer and Discharge Capacity]

Examples 1 to 5 and comparative example 1 in which mixture filling densities of positive electrode mixture layers were varied for checking the relations between the same and discharge capacities of the nonaqueous electrolyte secondary batteries are now described.

[Preparation of Positive Electrode Active Material]

### EXAMPLE 1

First, lithium iron phosphate (LiFePO₄), a conductive agent composed of acetylene black and a binder composed of polyvinylidene fluoride were mixed with each other to be 88.2:4.9:6.9 in mass ratio, and a proper quantity of N-methylpyrrolidone (NMP) was added thereto for preparing slurry. This slurry was applied to a collector of aluminum foil by a doctor blade method for preparing a positive electrode mixture layer, which in turn was thereafter dried at 80° C. with a hot plate. Then, a positive electrode section was prepared by cutting this dry positive electrode mixture layer into a size of 2 cm by 2 cm. Then, this cut positive electrode section was rolled with a pressure roller until the mixture filling density of the positive electrode mixture layer was 2.4 g/cm³, and thereafter vacuum-dried at 100° C. for preparing a positive electrode according to Example 1. The mixture filling density of the positive electrode mixture layer is obtained as follows:

Mixture filling density of positive electrode mixture layer=mass of positive electrode mixture layer+volume of positive electrode mixture layer

(Mass of positive electrode mixture layer=mass of positive electrode active material+mass of conductive agent+mass of binder)

### EXAMPLE 2

In this Example 2, the positive electrode was prepared through the same process as Example 1, except that a positive electrode section was rolled with a pressure roller until the mixture filling density of a positive electrode mixture layer was 2.1 g/cm³.

### EXAMPLE 3

In this Example 3, the positive electrode was prepared through the same process as Example 1, except that a positive electrode section was rolled with a pressure roller until the mixture filling density of a positive electrode mixture layer was 1.9 g/cm³.

### EXAMPLE 4

In this Example 4, the positive electrode was prepared through the same process as Example 1, except that a positive electrode section was rolled with a pressure roller until the mixture filling density of a positive electrode mixture layer was 1.8 g/cm³.

### EXAMPLE 5

In this Example 5, the positive electrode was prepared through the same process as Example 1, except that a positive electrode section was rolled with a pressure roller until the mixture filling density of a positive electrode mixture layer was 1.7 g/cm³.

### COMPARATIVE EXAMPLE 1

In this comparative example 1, the positive electrode was prepared through the same process as Example 1, except that a positive electrode section was rolled with a pressure roller until the mixture filling density of a positive electrode mixture layer was 1.5 g/cm³.

[Evaluation of Charge/Discharge Characteristics with Test Cell]

The test cell shown in FIG. 1 was prepared for evaluating discharge characteristics of the nonaqueous electrolyte secondary batteries having the positive electrodes according to Examples 1 to 5 and comparative example 1. In a test cell 10, a positive electrode 1 and a negative electrode 2 were arranged in a test cell container 6 of glass so that the positive electrode 1 and the negative electrode 2 were opposed to each other through a separator 3, as shown in FIG. 1. A reference electrode 4 was also arranged in the test cell 10. A nonaqueous electrolyte 5 was injected into the test cell container 6, thereby preparing the test cell 10. Each of those prepared according to Examples 1 to 5 and comparative example 1 was employed as the positive electrode 1. Lithium metals were employed as the negative electrode 2 and the reference electrode 3 respectively. A substance prepared by dissolving lithium phosphorus hexafluoride (LiPF₆) into a solvent prepared by mixing ethylene carbonate (EC) and 1,2-dimethoxyethane (DME) with each other in the volume ratio 3:7 as a solute to be 1 mol/l was employed as the nonaqueous electrolyte 5.

### [Charge/Discharge Test]

A charge/discharge test was conducted in the test cell 10 prepared in the aforementioned manner. As to the conditions for this charge/discharge test, charge was carried out up to a charge termination potential of 4.2 V (vs. Li/Li⁺) with a charging current rate of 0.2 It and discharge was thereafter carried out up to a discharge termination potential of 2.0 V (vs. Li/Li⁺) with discharging current rates of 0.2 It, 1 It and 2 It. The following calculations have been made on the assumption that the discharge capacity (discharge capacitive density) per 1 g of positive electrode active material is 150 mAh/g.

When the positive electrode is coated with 50 mg of positive electrode active material, the discharge capacity of the positive electrode is calculated as follows:

Discharge capacity (mAh)=discharge capacitive density (mAh/g)×positive electrode active material mass (g)=150 (mAh/g)×0.05 (g)=7.5 mAh

With this discharge capacity of the positive electrode, current values at the respective discharge rates were obtained from the following calculation formulas:

Current value at 2 It: 7.5 (mAh)/[1/2](h)=15 mA

Current value at 1 It: 7.5 (mAh)/[1/1](h)=7.5 mA

Current value at 0.2 It: 7.5 (mAh)/[1/0.2](h)=1.5 mA

TABLE 1

| | Positive Electrode | | | |
|---|---|---|---|---|
| | Mixture Filling | Discharge Capacity per | | |
| | Density | Active Material (mAh/g) | | |
| | (g/cm³) | 0.2It | 1It | 2It |
| Example 1 | 2.4 | 149.6 | 133.5 | 123.9 |
| Example 2 | 2.1 | 146.8 | 132.2 | 121.2 |
| Example 3 | 1.9 | 145.7 | 119.5 | 93.8 |
| Example 4 | 1.8 | 147.6 | 120.8 | 92.0 |
| Example 5 | 1.7 | 136.3 | 93.7 | 65.1 |
| Comparative | 1.5 | 147.3 | 82.7 | 5.5 |
| Example 1 | | | | |

Examples 1 to 5 and comparative example 1 are now described with reference to the above Table 1. As obvious from Table 1, the test cell 10 having the positive electrode 1 according to comparative example 1 setting the mixture filling density of the positive electrode mixture layer to 1.5 g/cm³ could obtain only an extremely low discharge capacity (5.5 mAh/g) in high-rate (2 It) discharge. On the other hand, the test cell 10 having the positive electrode 1 according to each of Examples 1 to 5 setting the mixture filling density of the positive electrode mixture layer to at least 1.7 g/cm³ could obtain a large discharge capacity (at least 65.1 mAh/g) as compared with comparative example 1 setting the mixture filling density of the positive electrode mixture layer to 1.5 g/cm³ also in high-rate (2 It) discharge.

In other words, it is conceivable that adhesiveness between the positive electrode active material and the conductive agent, between the conductive agent and the collector and between the collector and the positive electrode active material was reduced due to the low mixture filling density of 1.5 g/cm³ in the test cell 10 according to comparative example 1, whereby electron conductivity in the positive electrode 1 was so insufficient that only a low discharge capacity could be obtained in high-rate discharge carried out with relatively large current. In the test cell 10 with the positive electrode 1 according to each of Examples 1 to 5, on the other hand, it is conceivable that the mixture filling density was so increased to at least 1.7 g/cm³ that adhesiveness between the positive electrode active material and the conductive agent, between the conductive agent and the collector and between the collector and the positive electrode active material could be improved, whereby electron conductivity in the positive electrode 1 could be improved. Thus, it is conceivable that a large discharge capacity could be maintained not only in ordinary discharge but also in high-rate discharge carried out with relatively large current. According to each of Examples 1 to 5 employing the nonaqueous electrolyte containing the solvent containing 1,2-dimethoxyethane (DME) which is chain ether having low viscosity in ethylene carbonate (EC) having a high dielectric constant, further, the dielectric constant of the nonaqueous electrolyte can be increased while viscosity can be reduced, whereby the quantity of the nonaqueous electrolyte impregnated into the positive electrode mixture layer can be increased and the traveling speed of lithium ions can be improved. Thus, it is conceivable that a large quantity of lithium ions can move toward the nonaqueous electrolyte in the vicinity of the positive electrode active material in each of Examples 1 to 5 so that the lithium ion concentration can be improved in the nonaqueous electrolyte in the vicinity of the positive electrode active material during discharge, whereby the discharge capacity in high-rate discharge can be further improved.

[Relation Between Structure of Solvent of Nonaqueous Electrolyte and Discharge Capacity]

Examples 6 to 10 and comparative example 2 in which the types and rates of the solvents of the nonaqueous electrolytes were varied for checking discharge capacities of the nonaqueous electrolyte secondary batteries are now described.

### EXAMPLE 6

In this Example 6, the nonaqueous electrolyte was prepared by adding lithium phosphorus hexafluoride (LiPF₆) to a solvent prepared by mixing ethylene carbonate (EC), dimethyl carbonate (DMC) and 1,2-dimethoxyethane (DME) with each other in the volume ratios 3:6:1 as a solute to be 1 mol/l.

### EXAMPLE 7

In this Example 7, the nonaqueous electrolyte was prepared by adding lithium phosphorus hexafluoride to a solvent prepared by mixing ethylene carbonate (EC), dimethyl carbonate (DMC) and 1,2-dimethoxyethane (DME) with each other in the volume ratios 3:5:2 as a solute to be 1 mol/l.

### EXAMPLE 8

In this Example 8, the nonaqueous electrolyte was prepared by adding lithium phosphorus hexafluoride to a solvent prepared by mixing ethylene carbonate (EC), diethyl carbonate (DEC) and 1,2-dimethoxyethane (DME) with each other in the volume ratios 3:3.5:3.5 as a solute to be 1 mol/l.

### EXAMPLE 9

In this Example 9, the nonaqueous electrolyte was prepared by adding lithium phosphorus hexafluoride to a solvent prepared by mixing ethylene carbonate (EC) and Positive electrodes used in Examples 6 to 10 and comparative example 2 were identical to that in Example 1. Table 2 shows results.

TABLE 2

| | Volume Ratio | Discharge Capacity per | | |
|---|---|---|---|---|
| | of | Active Material (mAh/g) | | |
| | Electrolyte | 0.2It | 1It | 2It |
| Example 6 | EC/DMC/DME | 147.6 | 127.3 | 115.0 |
| | 3/6/1 | | | |
| Example 7 | EC/DMC/DME | 148.1 | 133.3 | 122.2 |
| | 3/5/2 | | | |
| Example 8 | EC/DEC/DME | 149.9 | 132.7 | 120.9 |
| | 3/3.5/3.5 | | | |
| Example 9 | EC/DME | 144.0 | 114.0 | 98.0 |
| | 5/5 | | | |
| Example 1 | EC/DME | 149.6 | 133.5 | 123.9 |
| | 3/7 | | | |
| Example 10 | EC/DME | 147.5 | 125.2 | 112.6 |
| | 1/9 | | | |
| Comparative | EC/DEC | 146.2 | 120.8 | 68.9 |
| Example 2 | 3/7 | | | |

Examples 1 and 6 to 10 and comparative example 2 are described with reference to the above Table 2. As obvious from Table 2, the discharge capacity was 68.9 mAh/g in high-rate discharge of 2 It and no sufficiently high discharge capacity could be obtained in comparative example 2 having the solvent of the nonaqueous electrolyte composed of ethylene carbonate (EC) and diethyl carbonate 1,2-dimethoxyethane (DME) with each other in the volume ratio 5:5 as a solute to be 1 mol/l.

### EXAMPLE 10

In this Example 10, the nonaqueous electrolyte was prepared by adding lithium phosphorus hexafluoride to a solvent prepared by mixing ethylene carbonate (EC) and 1,2-dimethoxyethane (DME) with each other in the volume ratio 1:9 as a solute to be 1 mol/l.

### COMPARATIVE EXAMPLE 2

In this comparative example 2, the nonaqueous electrolyte was prepared by adding lithium phosphorus hexafluoride to a solvent prepared by mixing ethylene carbonate (EC) and diethyl carbonate (DEC) with each other in the volume ratio 3:7 as a solute to be 1 mol/l.

[Evaluation of Charge/Discharge Characteristics and Charge/Discharge Test with Test Cell]

The aforementioned test cell 10 was prepared for conducting a charge/discharge test under the same conditions as the aforementioned case of Examples 1 to 5 and comparative example 1. In other words, charge was carried out up to a charge termination potential of 4.2 V (vs. Li/Li⁺) with a charging current rate of 0.2 It and discharge was thereafter carried out up to a discharge termination potential of 2.0 V (vs. Li/Li⁺) with discharging current rates of 0.2 It, 1 It and 2 It. (DEC) which is chain carbonate. In each of Examples 1 and 6 to 10 having the solvent of the nonaqueous electrolyte containing ethylene carbonate (EC) and 1,2-dimethoxyethane (DME) which is chain ether, on the other hand, a high discharge capacity (at least 98.0 mAh/g) could be obtained also in high-rate discharge of 2 It.

In other words, the dielectric constant of the nonaqueous electrolyte is high while the viscosity is increased in comparative example 2 having the nonaqueous electrolyte containing not chain ether but diethyl carbonate (DEC) which is chain carbonate inferior in dielectric constant and viscosity as compared with chain ether, whereby the traveling speed of lithium ions from the negative electrode is slowed down in high-rate discharge of 2 It in the electrode in which voids in the positive electrode mixture are reduced in size by setting the positive electrode mixture filling density to at least 1.7 g/cm³. Therefore, it is conceivable that the lithium ion concentration is so reduced in the electrolyte in the vicinity of the positive electrode active material during discharge that only a low discharge capacity can be obtained in comparative example 2. In each of Examples 1 and 6 to 10 employing the nonaqueous electrolyte at least containing ethylene carbonate (EC) having a high dielectric constant and 1,2-dimethoxyethane (DME) which is chain ether having low viscosity, on the other hand, the dielectric constant of the nonaqueous electrolyte can be increased while the viscosity can be reduced, whereby the quantity of the nonaqueous electrolyte contained in the positive electrode mixture layer can be increased and the traveling speed of lithium ions can be improved. Thus, it is conceivable that a large quantity of lithium ions can move toward the nonaqueous electrolyte in the vicinity of the positive electrode active material in each of Examples 1 and 6 to 10 so that the lithium ion concentration can be improved in the nonaqueous electrolyte in the vicinity of the positive electrode active material during discharge, whereby the discharge capacity in high-rate discharge can be further improved.

Dimethyl carbonate (DMC) or diethyl carbonate (DEC) which is chain carbonate is so added to the solvent of the nonaqueous electrolyte in addition to ethylene carbonate (EC) and 1,2-dimethoxyethane (DME) which is chain ether as in each of the aforementioned Examples 6 to 8 that the chain carbonate can inhibit 1,2-dimethoxyethane (DME) which is chain ether from co-insertion into natural graphite also when the natural graphite is employed for a negative electrode active material. Thus, reduction of an initial charge/discharge effect and reduction of cyclicity resulting from co-insertion of 1,2-dimethoxyethane (DME) which is chain ether into natural graphite can be suppressed when the natural graphite is employed as the negative electrode active material.

The content of the chain ether in the solvent of the nonaqueous electrolyte is so set to at least 10% in volume ratio as in each of Examples 1 and 6 to 10 that the viscosity of the nonaqueous electrolyte can be reliably reduced, whereby the traveling speed of lithium ions can be reliably improved. Thus, the discharge capacity in high-rate discharge can be reliably improved.

Examples disclosed this time are to be considered as illustrative and not restrictive in all points. The range of the present invention is shown not by the above description of Examples but by the scope of claim for patent, and all modifications within the meaning and range equivalent to the scope of claim for patent are further included.

For example, while no treatment has been performed on the surface of lithium iron phosphate in each of the aforementioned Examples, the present invention is not restricted to this but carbon coatings may be formed or carbon treatment (surface treatment) such as carbon deposition may be performed on the surfaces of lithium iron phosphate particles or lithium sites may be partially replaced with a transition metal in order to improve electron conductivity, since lithium iron phosphate employed as the positive electrode active material has low electron conductivity.

While the example of not controlling the particle size of lithium iron phosphate employed as the positive electrode active material has been shown in each of the aforementioned Examples, the present invention is not restricted to this but the particle size of lithium iron phosphate may be controlled to not more than 10 μm. In this case, both of the median diameter and the mode diameter of the particle size of lithium iron phosphate in a case of measuring the same with a laser diffraction particle size distribution measuring apparatus are preferably set to not more than 10 μm, more preferably to not more than 5 μm. According to this structure, a lithium diffusion length in the particles can be controlled to be small in charge/discharge, whereby resistance following insertion/desorption of lithium is so reduced that electrode characteristics can be improved.

While the example of employing 1,2-dimethoxyethane as the chain ether has been shown in each of the aforementioned Examples, the present invention is not restricted to this but another chain ether such as ethoxymethoxyethane having low viscosity can be employed.

While the example of employing dimethyl carbonate or diethyl carbonate as the chain carbonate has been shown in each of the aforementioned Examples, the present invention is not restricted to this but still another chain carbonate such as ethylmethyl carbonate, methylpropyl carbonate, ethylpopyl carbonate or methylisopropyl carbonate can be employed. Further, a substance prepared by partially or entirely replacing hydrogen in a compound of such chain carbonate with fluorine can also be employed.

Cyclic carbonate, ester, cyclic ether, nitrile, amide or the like generally employed as a nonaqueous solvent for a battery may be further mixed into the aforementioned solvent. Vinylene carbonate, propylene carbonate, butylenes carbonate or the like can be employed as cyclic carbonate. Trifluoropropylene carbonate or fluoroethyl carbonate prepared by partially or entirely replacing hydrogen in such a compound with fluorine can be employed. Methyl acetate, ethyl acetate, propyl acetate, methyl propionate, ethyl propionate, γ-butylolactone or the like can be employed as ester. 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cionel, crown ether or the like can be employed as cyclic ether. Acetonitrile or the like can be employed as nitrile. Dimethylformamide or the like can be employed as amide.

While lithium phosphorus hexafluoride (LiPF₆) has been employed as the electrolyte in each of the aforementioned Examples, the present invention is not restricted to this but an electrolyte generally employed in a nonaqueous electrolyte battery can be employed in place of lithium phosphorus hexafluoride (LiPF₆). For example, LIAsF₆, LiBF₄, LiCF₃SO₃, LiN(C₁F₂₁₊₁SO₂)(CₘF₂ₘ₊₁SO₂) (l and m represent integers of at least 1), LiC(CₚF₂ₚ₊₁SO₂)(C_{q}F_{2q+1}SO₂)(CᵣF₂ᵣ₊₁SO₂) (p, q and r represent integers of at least 1), lithium difluoro(oxalate)borate (substance expressed in the following chemical formula 1) or the like can be employed. One such electrolyte may be used, or at least two such electrolytes may be combined with each other. This electrolyte is preferably employed in a concentration of 0.1 mol/l to 1.5 mol/l, preferably 0.5 mol/l to 1.5 mol/l in a nonaqueous solvent.

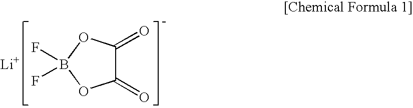

While the example of rolling the positive electrode mixture layer on the collector with the pressure roller has been shown in each of the aforementioned Examples, the present invention is not restricted to this but the positive electrode mixture layer may be rolled with another apparatus such as a pressing machine.

1. A nonaqueous electrolyte secondary battery comprising:
a positive electrode (1) including a collector and a mixture layer, formed on said collector, containing a positive electrode active material containing lithium iron phosphate, a conductive agent and a binder with said mixture layer exhibiting a mixture filling density of at least 1.7 g/cm³ after electrode formation; and
a nonaqueous electrolyte (5) containing a solvent containing ethylene carbonate and chain ether.

2. The nonaqueous electrolyte secondary battery according to claim 1, wherein
the solvent of said nonaqueous electrolyte (5) contains chain carbonate in addition to said ethylene carbonate and said chain ether.

3. The nonaqueous electrolyte secondary battery according to claim 2, wherein
said chain carbonate constituting the solvent of said nonaqueous electrolyte (5) is diethyl carbonate.

4. The nonaqueous electrolyte secondary battery according to claim 2, wherein
said chain carbonate constituting the solvent of said nonaqueous electrolyte (5) is dimethyl carbonate.

5. The nonaqueous electrolyte secondary battery according to claim 4, wherein
the content of said dimethyl carbonate in the solvent of said nonaqueous electrolyte (5) is at least 50% in volume ratio.

6. The nonaqueous electrolyte secondary battery according to claim 1, wherein
the content of said chain ether in the solvent of said nonaqueous electrolyte (5) is at least 10% in volume ratio.

7. The nonaqueous electrolyte secondary battery according to claim 1, wherein
said chain ether constituting the solvent of said nonaqueous electrolyte (5) is 1,2-dimethoxyethane.

8. The nonaqueous electrolyte secondary battery according to claim 1, wherein
the solvent of said nonaqueous electrolyte (5) is any one of a solvent containing said ethylene carbonate and said 1,2-dimethoxyethane, a solvent containing said ethylene carbonate, said 1,2-dimethoxyethane and said dimethyl carbonate and a solvent containing said ethylene carbonate, said 1,2-dimethoxyethane and said diethyl carbonate.

9. The nonaqueous electrolyte secondary battery according to claim 8, wherein
the solvent of said nonaqueous electrolyte (5) is the solvent containing said ethylene carbonate and said 1,2-dimethoxyethane.

10. The nonaqueous electrolyte secondary battery according to claim 8, wherein
the solvent of said nonaqueous electrolyte (5) is the solvent containing said ethylene carbonate, said 1,2-dimethoxyethane and said dimethyl carbonate.

11. The nonaqueous electrolyte secondary battery according to claim 8, wherein
the solvent of said nonaqueous electrolyte (5) is the solvent containing said ethylene carbonate, said 1,2-dimethoxyethane and said diethyl carbonate.

12. The nonaqueous electrolyte secondary battery according to claim 1, wherein
the content of said ethylene carbonate in the solvent of said nonaqueous electrolyte (5) is at least 10% in volume ratio.

13. The nonaqueous electrolyte secondary battery according to claim 1, wherein
said nonaqueous electrolyte (5) contains an electrolyte composed of lithium phosphorus hexafluoride.

14. The nonaqueous electrolyte secondary battery according to claim 1, wherein
said mixture layer contains the positive electrode active material containing lithium iron phosphate, a conductive agent containing acetylene black and a binder containing polyvinylidene fluoride.
